(19) United States
(12) Patent Application Publication
(10) Pub. No.: US 2025/0180133 A1
(43) Pub. Date: Jun. 5, 2025

(54) BREATHER

(71) Applicant: DES-CASE CORPORATION, Goodlettsville, TN (US)

(72) Inventors: Eric Cooper Pride, Nashville, TN (US); Ian Jeffrey de Groot, Swifterbant (NL); Gerben Eelke Gerken, Nieuw Vennep (NL)

(21) Appl. No.: 18/526,505

(22) Filed: Dec. 1, 2023

(51) Int. Cl. F16K 24/04

(52) U.S. Cl. CPC F16K 24/04

(57) ABSTRACT

A breather for a reservoir as disclosed herein may comprise a housing, a first end, and a second end. The housing may have a standpipe for at least receiving an air flow containing oil. The first end may be configured for at least receiving the air flow containing oil into the standpipe. The second end may be located at an opposite side of the standpipe from the first end. The second end may be parallel to the first end and configured for at least emitting air from the standpipe. The standpipe may be substantially cylindrical in shape and include first and second protrusions integrally formed in an inner wall of the standpipe. The first protrusion may have a first protrusion peak and the second protrusion may have a second protrusion peak. The first protrusion peak and the second protrusion peak may extend in opposite directions and form an airflow distance.

A portion of the disclosure of this patent document contains material that is subject to copyright protection. The copyright owner has no objection to this reproduction of the patent document or the patent disclosure, as it appears in the U.S. Patent and Trademark Office patent file or records, but otherwise reserves all copyright rights whatsoever.

### FIELD OF THE DISCLOSURE

The present invention relates generally to a breather which may be used to maintain oil while allowing for the flow of air. In optional embodiments, aspects of the invention may include a desiccant breather that precludes the splashing of oil on to undesirable portions of the breather and thus maintains a greater amount of oil within machinery and out of the air.

### BACKGROUND

Breathers are often used within industrial machinery or chemicals in allowing air exchange while usually controlling moisture and particulate absorption. Generally, breathers are used with an included desiccant so as to preclude moisture from accumulating within the machinery or the reservoir to which the breather is attached.

In configuring breathers to function most optimally for a specific function, different breathers may be disposable or possibly serviceable where they can be restored without disposal. Some industrial designs require breathers of a significantly durable condition as the machinery or processes can place mechanical stress upon the breathers.

Various designs of breathers are used in today's industry, some of which may include a desiccant. Many systems include desiccant breathers as moisture can be problematic, especially with hydraulic systems.

Additionally, in dealing with the various materials that are often created or used in industrial processes, controlling airborne particulate matter is often also a function of breathers. Both particulate matter as well as moisture can be destructive for hydraulic systems. Some breathers may also include filters specific to the particulate matter and thus, for example, can filter solid particulate contaminates at either a two- or four-micron level. In many instances, the industrial breathers may include both a filter for removing particulate matter as well as a desiccant for trapping moisture, thus providing a dual removal system.

Desiccant breathers may include a hygroscopic material, which may attract and retain water. In some breathers, silica gel may be used as it may attract a significant portion of its weight in water. Such designs may also include other media with the silica so as to prevent moisture and particulates for escape.

Additionally, the industry may also use additives to the desiccant breather such as carbon media to capture oil mist. As the carbon material can adhere to the oil, being a hydrocarbon, oil mist exiting the system may be lessened.

One possible issue is where oil from within the machinery contacts portions of the breather which one would not want oil contacting. From aspects such as filters or desiccant, oil is generally desired not to contact such portions and thus stay within the machinery. Problems may result where oil accumulates within the desiccant, resulting in the lessened capacity of the desiccant. Additionally, breathers may not allow sufficient airflow for optimum performance in instances where the oil has thoroughly contacted and layered on the various desiccants and/or filters within the breather.

Various designs of breathers are used in today's industry, some of which include a standpipe that receives at least air flow containing oil from the reservoir the breather is attached to. Accordingly, a need exists for improvements in oil breathers to preclude oil from industrial machinery from contacting portions of a breather which may cause problems.

### SUMMARY OF THE DISCLOSURE

This Summary of the Disclosure is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect in accordance with the optional embodiments disclosed herein is a breather for a reservoir. The breather may include a housing, a first end, and a second end. The housing may have a standpipe for at least receiving an air flow containing oil. The first end may be configured for at least receiving the air flow containing oil into the standpipe. The first end may have a single flow passage configured to receive both air flow and coalesced oil via the air flow containing oil. The second end may be located at an opposite side of the standpipe from the first end. The second end may be parallel to the first end and configured for at least emitting air from the standpipe. The standpipe may be substantially cylindrical in shape and include first and second protrusions integrally formed in an inner wall of the standpipe. The first protrusion may have a first protrusion peak and the second protrusion may have a second protrusion peak. The first protrusion peak and the second protrusion peak may extend in opposite directions and form an airflow distance.

In another aspect in accordance with the optional embodiments disclosed herein, each of the first and second protrusions may include a proximal curved section and a distal curved section.

In another aspect in accordance with the optional embodiments disclosed herein, the first and second protrusion peaks are curved.

In another aspect in accordance with the optional embodiments disclosed herein, an offset distance between the first protrusion peak and the second protrusion peak may be in a range of from 5 to 30 millimeters.

In another aspect in accordance with the optional embodiments disclosed herein, an offset distance between the first protrusion peak and the second protrusion peak may be similar to an inner diameter of the standpipe.

In another aspect in accordance with the optional embodiments disclosed herein, a gap distance between the first protrusion peak and the second protrusion peak may be in a range of from 1 to 10 millimeters.

In another aspect in accordance with the optional embodiments disclosed herein, the airflow distance may be in a range of from 1 to 20 millimeters.

In another aspect in accordance with the optional embodiments disclosed herein, the first and second protrusions may be located closer to a proximal end of the standpipe than to a distal end of the standpipe.

In another aspect in accordance with the optional embodiments disclosed herein, in a linear cross-section of the standpipe, the first and second protrusion may form an S-shaped curve.

In another aspect in accordance with the optional embodiments disclosed herein, the first and second protrusions may extend from the inner wall of the standpipe at least halfway across an inner diameter of the standpipe.

In another aspect in accordance with the optional embodiments disclosed herein, the first and second protrusions extend from the inner wall of the standpipe no further than halfway across an inner diameter of the standpipe.

In another aspect in accordance with the optional embodiments disclosed herein, the standpipe includes first and second indentations formed in an outer wall of the standpipe. The first and second indentations may correspond to the first and second protrusions, respectively. The standpipe may include one or more ribs extending within the first and second indentations.

In another aspect in accordance with the optional embodiments disclosed herein, the standpipe may include third and fourth protrusions integrally formed in the inner wall of the standpipe.

In another aspect in accordance with the optional embodiments disclosed herein, the first and second protrusions include an airflow reduction factor of less than 20.

Another aspect in accordance with the optional embodiments disclosed herein is a standpipe for a breather. The standpipe may comprise a substantially cylindrical body and first and second protrusions. The first and second protrusions may be integrally formed in an inner wall of the standpipe. The first protrusion may have a first protrusion peak and the second protrusion may have a second protrusion peak. The first protrusion peak and the second protrusion peak may extend in opposite directions forming an airflow distance. In a linear cross-section of the standpipe, the first and second protrusions may form an S-shaped curve.

In another aspect in accordance with the optional embodiments disclosed herein, the first and second protrusions may extend from the inner wall of the standpipe at least halfway across an inner diameter of the standpipe.

In another aspect in accordance with the optional embodiments disclosed herein, the first and second protrusions may extend from the inner wall of the standpipe no further than halfway across an inner diameter of the standpipe.

Numerous objects, features and advantages of the present invention will be readily apparent to those skilled in the art upon a review of the following description in conjunction with the accompanying drawings.

### BRIEF DESCRIPTION OF THE DRAWINGS

FIG. 1 is a top perspective view of a breather.

FIG. 2 is a bottom perspective view of the breather of FIG. 1.

FIG. 3 is a side elevation view of the breather of FIG. 1.

FIG. 4 is a cross-sectional side elevation view of the breather of FIG. 1.

FIG. 5 is a bottom view of the breather of FIG. 1.

FIG. 6 is a bottom perspective view of a standpipe of the breather of FIG. 1.

FIG. 7 is a top perspective view of the standpipe of FIG. 6.

FIG. 8 is a side elevation view of the standpipe of FIG. 6.

FIG. 9 is a side elevation view of the standpipe of FIG. 6.

FIG. 10 is a cross-sectional side elevation view of the standpipe of FIG. 6.

FIG. 11 is a cross-sectional side elevation view of the standpipe of FIG. 6.

FIG. 12 is a side elevation view of the standpipe of FIG. 6.

FIG. 13 is a top view of the standpipe of FIG. 6.

FIG. 14 is a bottom view of the standpipe of FIG. 6.

FIG. 15 is a schematic view of the breather of FIG. 1 including a controller, humidity sensor, pressure sensor, and temperature sensor.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

The words “connected,” “attached,” “joined,” “mounted,” “fastened,” and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or multiple components.

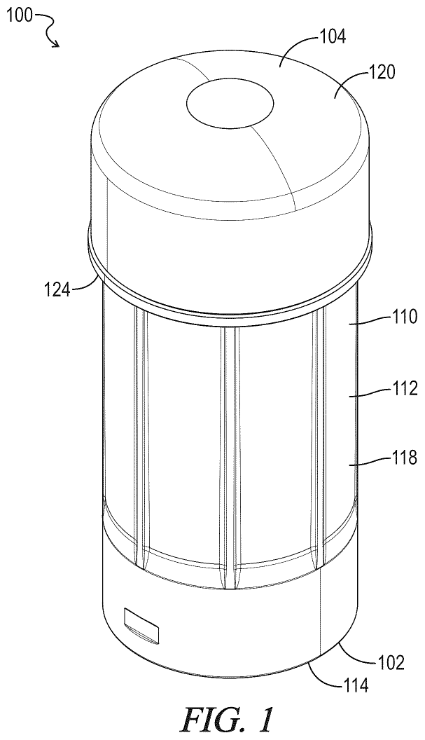

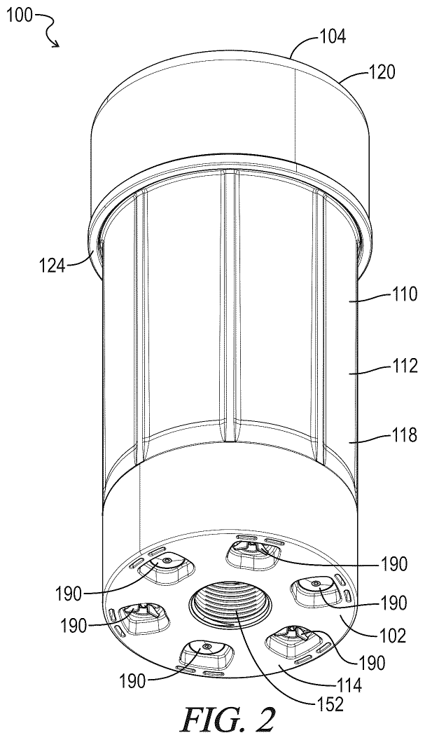

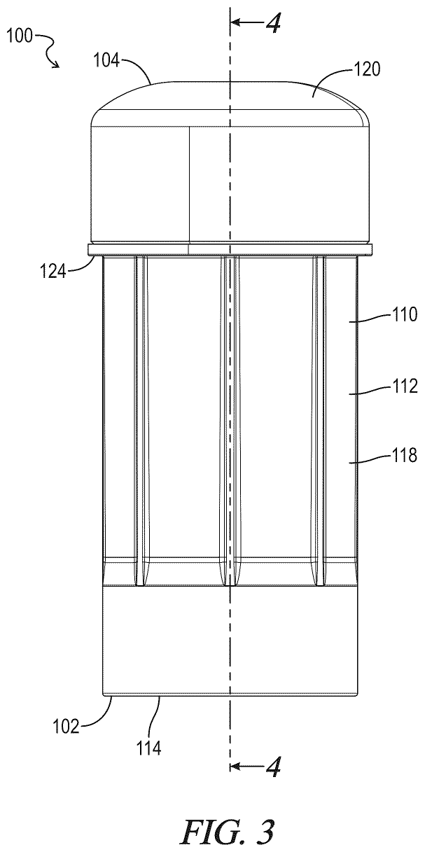

Referring now to the figures, and specifically FIGS. 1-5, a breather for a reservoir is shown and generally designated by the number 100. The breather 100 may be operable to be removably coupled to a reservoir or other machinery. The reservoir or other machinery may experience, via the breather 100, in-breathing and out-breathing. During out-breathing, air may be expelled from the reservoir through the breather 100. During in-breathing, air from outside the reservoir may be pulled into the reservoir through the breather 100.

As used herein, the proximal end 102 of the breather 100 may refer to the end closest to the reservoir. The proximal end 102 may also be referred to herein as a first end 102 of the breather 100. The distal end 104 of the breather 100 may refer to an end opposite the proximal end 102 and furthest from the reservoir. The distal end 104 may also be referred to herein as a second end 104 of the breather 100. One of skill in the art will appreciate that the breather 100 may be mounted in various configurations and orientations respective to the reservoir.

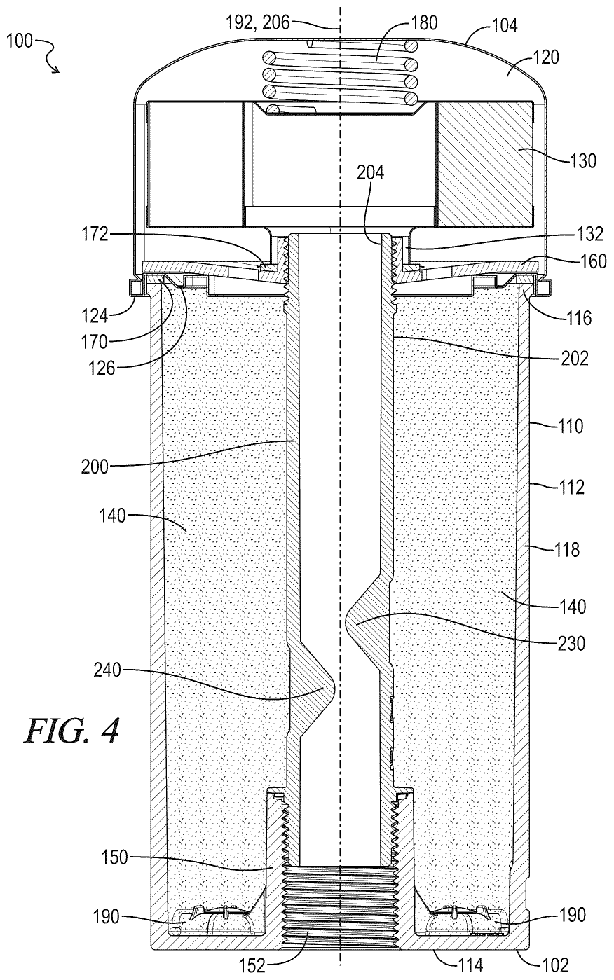

The breather 100 may include a housing 110. The housing 110 may include a rigid or semi-rigid body 112 having a proximal end 114, a distal end 116, and an outer wall 118. The proximal end 114 may also be referred to herein a first end 114. The distal end 116 may also be referred to herein as a second end 116. An internal cylinder 150, shown in FIG. 4, may extend distally from the proximal end 114 of the body 112 toward the distal end 116 of the body 112. The internal cylinder 150 may extend a distance less than the length of the body 112. The internal cylinder 150 may include internal threads 152. The internal thread 152 may be operable to connect the breather 100 to a reservoir or other machinery.

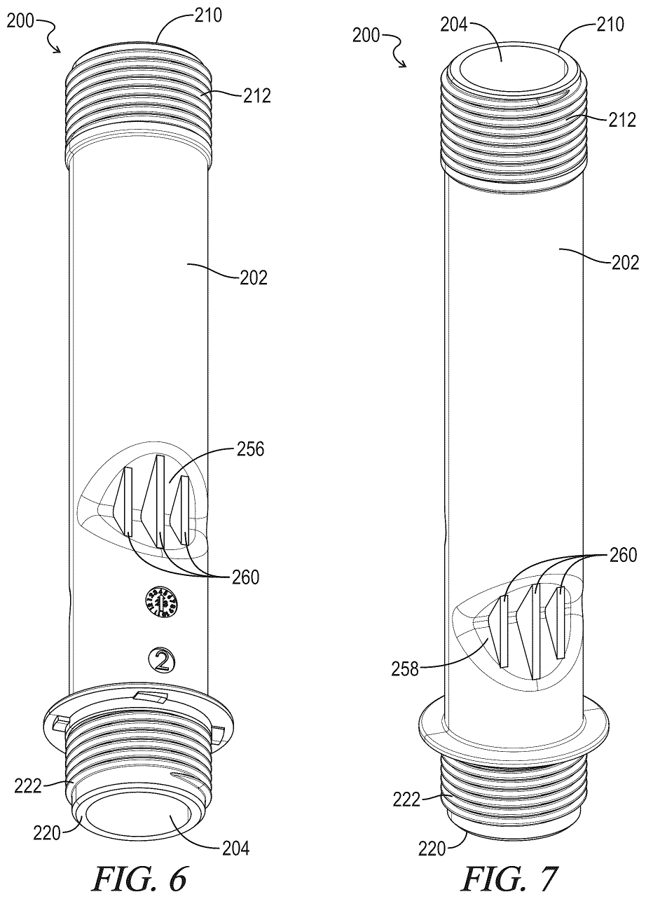

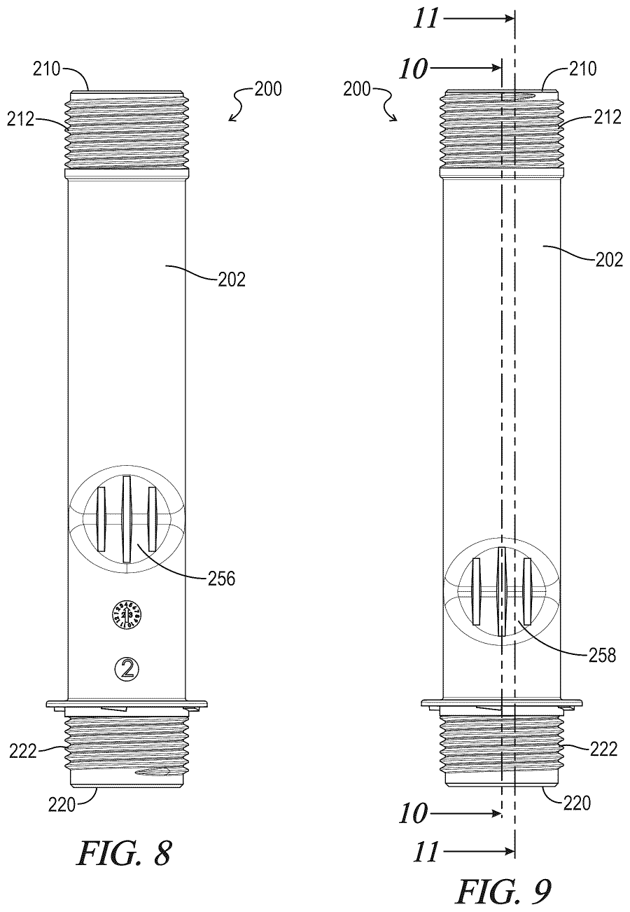

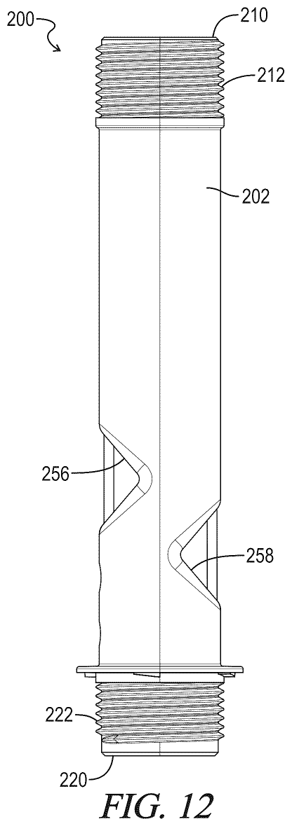

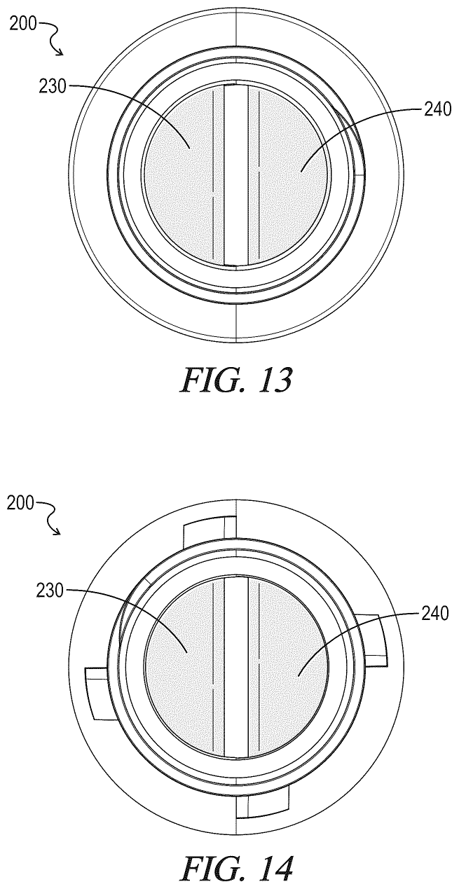

Referring now to FIGS. 4 and 6-14, the breather 100 may include a generally cylindrical standpipe 200 configured to at least receive an air flow which may contain oil from a reservoir/machinery. Optionally, the standpipe may be referred to as a centerpipe or center tube. The standpipe 200 may also be configured to receive an air flow containing moisture. The standpipe 200 may include an outer wall 202 and an inner wall 204. The standpipe 200 may include a central axis 206 extending a length of the standpipe 200. The standpipe 200 may include a standpipe distal end 210 and a standpipe proximal end 220. The standpipe distal end 210 may be located at an opposite side of the standpipe 200 from the proximal end 220 and be parallel to the proximal end 220. The standpipe distal end 210 may include threaded section 212 and the standpipe proximal end 220 may include threaded section 222. The threaded sections 212, 222 may be disposed about the outer wall 202 of the standpipe 200.

The standpipe proximal end 220 may be configured for at least receiving an air flow containing oil into the standpipe 200. The proximal end 220 may have a single flow passage configured to receive both air flow and oil via the air flow containing oil. The standpipe distal end 210 may be configured for at least emitting air from the standpipe 200.

As shown in FIG. 4, the standpipe proximal end 220 may be coupled to the proximal end 114 of the body 112. In certain optional embodiments, the standpipe proximal end 220 may be removably coupled to internal cylinder 150 wherein the threaded section 222 of the standpipe proximal end 220 engages internal threads 152 of the internal cylinder 150. The threaded section 222 of the standpipe proximal end 220 may have a length that is less than the length of the internal threads 152 of the internal cylinder 150. Thus, other attachments may be threaded onto internal threads 152 of the internal cylinder, or the reservoir may be coupled to the breather 100 via the internal threads 152 of the internal cylinder 150. In other optional embodiments, the standpipe proximal end 220 may be permanently affixed to the proximal end 114 of the body 112. As used herein “permanently affixed” refers to a condition where the relevant components were not intended to be separated.

As shown in FIG. 4, the housing 110 of the breather 100 may further include a cap 120. The cap 120 may be coupled to the body 112 at or near the distal end 116. A filter 130 may be located at least partially within the cap 120. The filter 130 may be a particulate filter, moisture filter, or the like. The filter 130 may include a central threaded member 132 extending from a bottom portion of the filter 130.

The standpipe 200 may extend from the proximal end 114 of the body 112 of the housing 110, through the body 112 of the housing 110, and distally from the end 116 of the body 112 of the housing 110. A top plate 160 may be positioned at or near the distal end 116 of the body 112. The top plate 160 may include a central hole configured to receive the threaded section 212 of the standpipe distal end 210. In certain optional embodiments, the central hole of the top plate 160 may be threaded, while in other optional embodiments the central hole of the top plate 160 may not be threaded. The top plate 160 may include a plurality of holes configured to at least allow air to pass therethrough.

The cap 120 may include a bottom edge 124. The bottom edge 124 may have a circumference larger than circumference of the body 112 of the housing 110. Thus, the bottom edge 124 of the cap 120 may be operable to surround a portion of the outer wall 118 of the body 112 of the housing 110. The cap 120 may include a flange 126. The flange 126 may extend inward from the bottom edge 124 and toward a center of the cap 120. When the cap 120 is placed on the body 112 of the housing 110, the flange 126 may extend towards a central axis 192 of the body 112.

In certain optional embodiments, the cap 120 may be mounted to the body 112 of the housing 110. A sealer ring 170 may be disposed between the distal end 116 of the body 112 of the housing 110 and the flange 126 of the cap 120. The central hole of the top plate 160 may receive the standpipe distal end 210 such that the top plate 160 contacts the flange 126 of the cap 120. The central threaded member 132 of the filter 130 may also be threaded onto the distal end 210 of the standpipe 200 wherein the filter 130 is located distal to the top plate 160. In certain optional embodiments, the filter 130 may rotate about the threaded section 212 of the standpipe distal end 210 until the filter 130, and specifically the central threaded member 132, contact the top plate 160. The filter 130 may push the top plate 160 toward the distal end 116 of the body 112 of the housing 110 and squeeze the sealer ring 170 and flange 126 of the cap 120. In other optional embodiments, a gap may exist between the filter 130 and the top plate 160. A top plate gasket 172 may be positioned adjacent to the central hole of the top plate 160. The top plate gasket 172 may be operable to create an air-tight or substantially air-tight seal.

A spring 180 may be positioned between the filter 130 and the cap 120 of the cap 120. The spring 180 may be operable to bias the cap 120 upward and thus away from the body 112 of the housing 110. The spring 180 biasing the cap 120 upward may create an air-tight or substantially air-tight seal between the bottom edge 124 and flange 126 of the cap 120 and the distal end 116 of the body 112 of the housing 110. Thus, the cap 120 may be sealed to the body 112 via an air-tight or substantially air-tight seal. The cap 120, top plate 160, and filter 130 may be mounted to the standpipe 200 and body 112 in various orientations not limited to the exemplary orientation discussed herein.

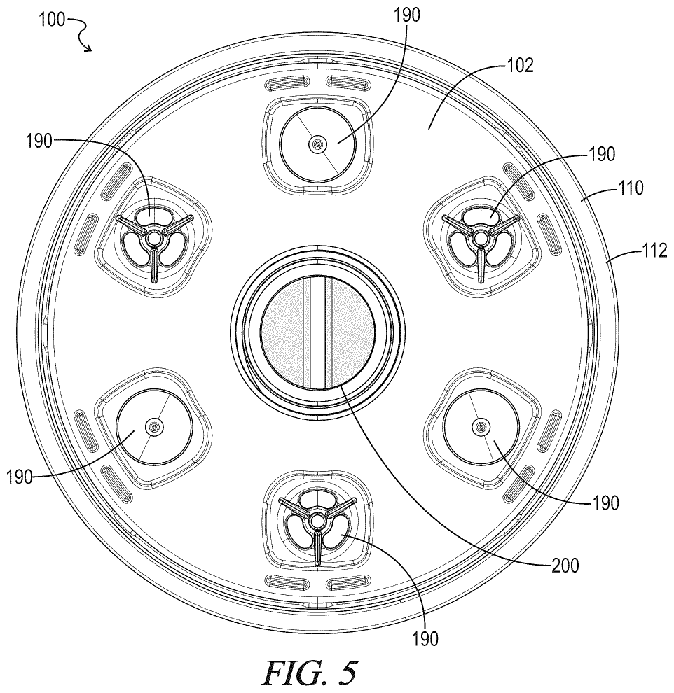

Referring now to FIG. 5, the proximal end 114 of the body 112 of the housing 110 may contain a plurality of valves 190. The valves 190 may be pressure/vacuum relief valves. In certain optional embodiments, the valves 190 may allow for single-direction air flow. In other optional embodiments, the valves 190 may allow for multi-directional air flow. As shown in the illustrated embodiment, when the breather 100 contains a plurality of valves 190 that allow for single-direction air flow, some of the valves 190 may be configured for in-breathing and some of the valves 190 may be configured for out-breathing. While the illustrated embodiment includes six valves 190, one of skill in the art will appreciate that it is within the spirit and scope of the present disclosure for the breather 100 to include less than or more than six valves.

Referring back to FIG. 4, the breather 100 may include desiccant 140. The desiccant 140 may be positioned within the housing 110 such that air passing through the breather 100 from outside the breather 100 to the inside of the reservoir or from inside the reservoir to outside the breather 100 must pass through the desiccant 140. In other optional embodiments, foam may be positioned within the housing 110.

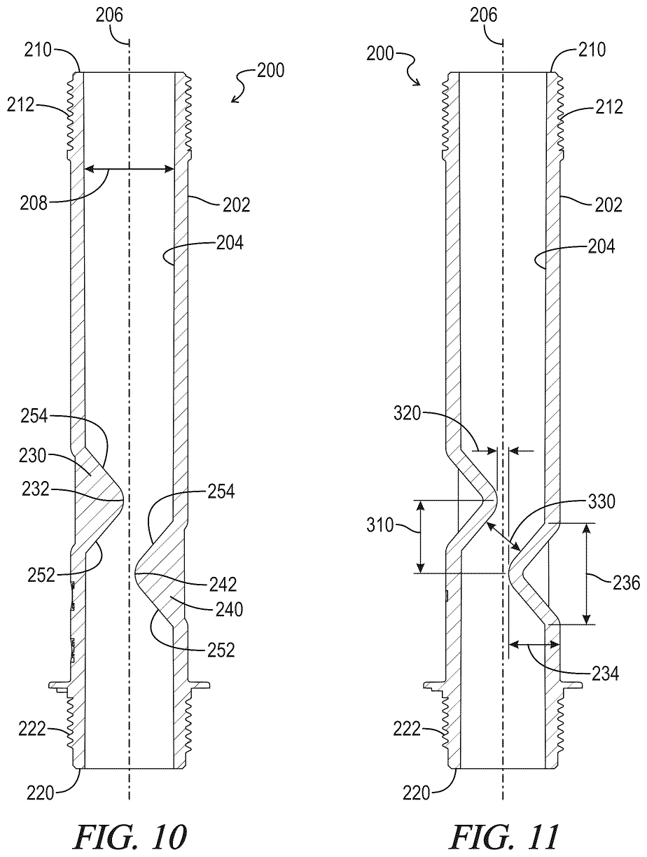

Referring now to FIGS. 10-11, the standpipe 200 may include a first protrusion 230 and a second protrusion 240. The first and second protrusions 230, 240 may be integrally formed in an inner wall 204 of the standpipe 200. The first protrusion 230 may include a first protrusion peak 232 and the second protrusion 240 may include a second protrusion peak 242. The “peak” as used herein may refer to the portion of the protrusion 230, 240 that extends furthest from the inner wall 204.

Each of the first and second protrusions 230, 240 may include a proximal sloped section 252 and a distal sloped section 254. The proximal sloped section 252 may rise from the inner wall 204 of the standpipe 200 on a proximal side of the respective protrusion peak 232, 242. The distal sloped section 254 may rise from the inner wall 204 of the standpipe 200 on a distal side of the respective protrusion peak 232, 242. The sloped sections may be curved or may be generally straight in different embodiment. In some embodiments, the sloped sections may be understood to be about perpendicular to the inner wall, whereas forming different angles in other embodiments. The proximal sloped section 252 and distal sloped section 254 may converge at the protrusion peak 232, 242 of the respective protrusion 230, 240. The first and second protrusion peaks 232, 242 may be curved. Thus, the first and second protrusion peaks 232, 242 and the first and second protrusions 230, 240 may be curved. However, one of skill in the art will appreciate that it is within the spirit of the present disclosure that the first and second protrusions 230, 240 may include proximal and distal linear members converging at a pointed protrusion peak.

The first and second protrusions 230, 240 may be located nearer to the proximal end 220 of the standpipe 200 than to the distal end 210 of the standpipe 200. In certain optional embodiments, the standpipe 200 may include more than two protrusions. For example, the standpipe 200 may include a third protrusion and a fourth protrusion. It may be desirable in certain use applications to include more than two protrusions, such as applications where there is a heightened risk of oil flow traversing the standpipe 200. The standpipe 200 may include an odd or even number of protrusions. While the protrusions in the illustrated embodiments are grouped in pairs, the protrusions in other optional embodiments may not be grouped at all or may be grouped in pairs of 3 or more.

The standpipe 200 may include a first indentation 256 and a second indentation 258. The first and second indentations 256, 258 may be formed in an outer wall 202 of the standpipe 200. The first and second indentations 256, 258 may correspond to the first and second protrusions 230, 240, respectively. Thus, the indentation may be a result of the protrusion being formed in the standpipe 200. The standpipe 200 may further include one or more ribs 260 extending within the first and second indentations 256, 258. The ribs 260 may extend in the proximal/distal direction and be operable to provide strength and stability to the standpipe 200.

The first and second protrusion peaks 232, 242 may extend in opposite directions. The first and second protrusion peaks 232, 242 may extend perpendicular to the inner wall 204 of the standpipe 200.

The standpipe 200 may include an offset distance 310 between the first protrusion peak 232 and the second protrusion peak 242. The offset distance 310 may refer to the distance between the first protrusion peak 232 and the second protrusion peak 242 along the central axis 206 of the standpipe 200. The offset distance 310 may be in a range of from 5 to 30 millimeters, in some embodiments from 12 to 20 millimeters, and in some embodiments from 14 to 18 millimeters. In certain optional embodiments, the offset distance 310 may be equal to an inner diameter 208 of the standpipe 200.

The standpipe 200 may include a gap distance 320 between the first protrusion peak 232 and the second protrusion peak 242. The gap distance 320 may refer to the distance between the first protrusion peak 232 and the second protrusion peak 242 perpendicular to the central axis 206 of the standpipe 200. The gap distance 320 may be in a range of from 1 to 10 millimeters, in some embodiments between 2 and 5 millimeters and in some embodiments from 2 to 3 millimeters.

The standpipe 200 may include an airflow distance 330. The first protrusion peak 232 and the second protrusion peak 242 extending in opposite direction may form the airflow distance 330. The airflow distance 330 may refer to the closest distance between the first protrusion 230 and the second protrusion 240. The airflow distance could be parallel to the central axis 206 of the standpipe 200, perpendicular to the central axis 206 of the standpipe 200, or any other orientation. The airflow distance 330 may be in a range of from 1 to 20 millimeters, in some embodiments from 3 to 16 millimeters, some embodiments 6 to 13 millimeters, and in some embodiments 9 to 10 millimeters.

In certain optional embodiments, the first and second protrusions 230, 240 may extend from the inner wall 204 of the standpipe 200 at least halfway across the inner diameter 208 of the standpipe 200. In other optional embodiments, the first and second protrusions 230, 240 may extend from the inner wall 204 of the standpipe 200 no further than halfway across the inner diameter 208 of the standpipe 200.

In a linear cross-section of the standpipe 200, as shown in FIGS. 10-11, the first and second protrusions 230, 240 may form an S-shaped curve. In embodiments of the standpipe 200 having more than two protrusions, the standpipe 200 may have multiple S-shaped curves formed therein. Thus, the standpipe 200 may direct the air flow within the standpipe through the S-shaped curve. The positioning of the first and second protrusions 230, 240 and the first and second protrusion peaks 232, 242 may be altered in certain optional embodiments depending on the desired functionality. The offset distance 310, gap distance 320, and airflow distance 330 may be adjusted. A height 234 and width 236 of each protrusion 230, 240 may be adjusted. The first protrusion 230 may be identical to the second protrusion 240 in certain optional embodiments. In other optional embodiments, the first protrusion 230 and the second protrusion 240 may not be identical.

The first and second protrusions 230, 240 may include an airflow reduction factor no greater than 20, in some embodiments no greater than 10, and in some embodiments no greater than 5. The airflow reduction factor may refer to the percent reduction in airflow velocity caused by the first and second protrusions 230, 240 as compared to a standpipe 200 of similar diameter but lacking the protrusions. Altering the offset distance 310, gap distance 320, airflow distance 330, protrusion height 234, and/or protrusion width 236 may affect the airflow reduction factor.

Increasing the airflow distance 330 may decrease the airflow reduction factor. Decreasing the airflow distance 330 may increase the airflow reduction factor. Further, increasing the number of protrusions within the standpipe 200 may increase the airflow reduction factor.

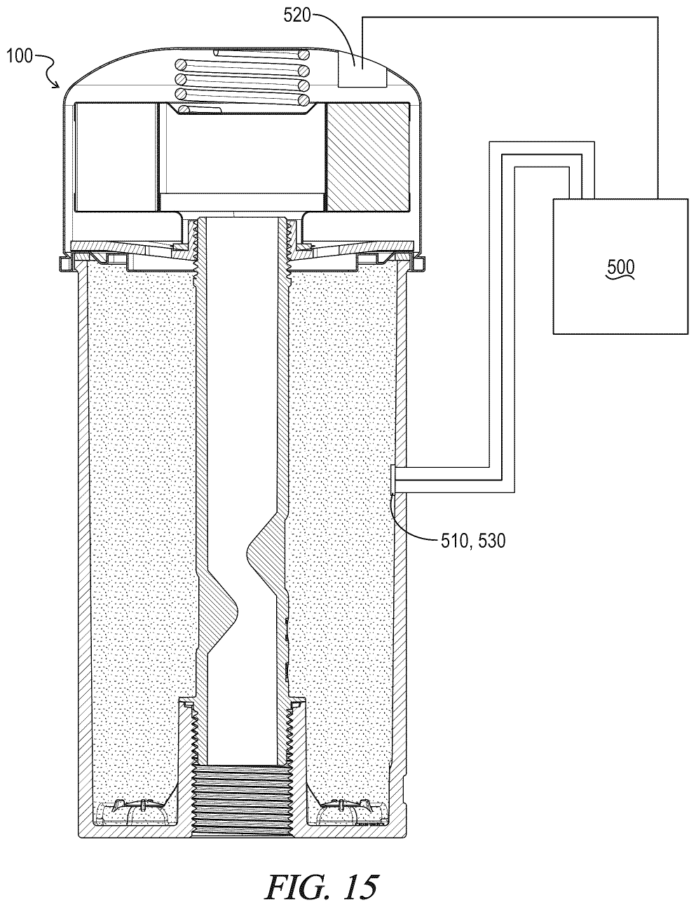

Referring now to FIG. 15, in certain optional embodiments, the breather 100 may include a humidity sensor 510, a temperature sensor 530, and/or a pressure sensor 520. Each of the humidity sensor 510, temperature sensor 530, and pressure sensor 520 may be associated with the housing 110 of the breather 100. The humidity sensor 510 may be positioned within the housing 110. The humidity sensor 510 may be operable to provide a humidity signal indicative of the humidity level adjacent to the humidity sensor 510. The temperature sensor 530 may be operable to provide a temperature signal indicative of a temperature adjacent to the temperature sensor 530. The pressure sensor 520 may be operable to provide a pressure signal indictive of the air pressure adjacent to the pressure sensor 520.

Each of the humidity sensor 510, temperature sensor 530, and pressure sensor 520 may be electrically connected to a controller 500. In certain optional embodiments, the humidity sensor 510 may be integral with the temperature sensor 530. Further, in certain optional embodiments, the housing 110 may include an adapter configured to locate the humidity sensor 510, temperature sensor 530, and/or pressure sensor 520 remote from a main portion of the housing 110.

In certain optional embodiments, the controller 500 may be local to the housing 110. In other optional embodiments, the controller 500 may be remote from the housing 110. The controller 500 may be connected to the humidity sensor 510, temperature sensor 530, and/or pressure sensor 520 via a wired or wireless communications link. The communications link may be analog or digital.

The controller 500 may be operable to determine an end of life condition of the breather 100 as a function of the humidity signal received from the humidity sensor 510. In other optional embodiments, the controller 500 may be operable to determine the end of life condition of the breather 100 as a function of the humidity signal received from the humidity sensor 510 and the temperature sensor received from the temperature sensor 530. The controller 500 may use the temperature signal and the humidity signal to determine a relative humidity associated with the desiccant 140.

In certain optional embodiments, during in-breathing, air flow from outside the breather may be drawn into the breather 100 through the valves 190 at the proximal end 114 of the body 112. Air from outside the breather 100 may contain moisture, particulate, or other debris. As the air flow moves through the body 112 of the housing 110, the air may pass through the desiccant 140. The desiccant may remove moisture from the air. In certain optional embodiments, the breather may not contain desiccant. The air flow may then move through the holes of the top plate 160 and pass through the filter 130. The filter 130 may remove particulate or other debris from the air flow. The air flow may then move in a proximal direction through the standpipe 200 before entering the reservoir. Thus, air flow from outside the breather 100 may be drawn into the reservoir with reduced moisture and particulate content.

In certain optional embodiments, during out-breathing, air flow from within the reservoir may enter the breather 100. The air flow may contain oil. The air flow may enter the proximal end 220 of the standpipe 200. As the air flow makes its way distally through the standpipe 200, oil may contact the inner wall 204 of the standpipe 200. The first and second protrusions 230, 240 may increase the amount of oil that coalesces along the inner wall 204 of the standpipe 200. The air may flow through the S-shaped curve created by the first and second protrusions 230, 240 and oil may coalesce along the protrusions 230, 240. Oil that is coalesced as it enters the standpipe 200 may then drain back into the reservoir under the influence of gravity. The oil free air may then exit the distal end 210 of the standpipe 200, flow through the filter 130, through the desiccant 140, and out of the valves 190.

One advantage of the first and second protrusions 230, 240 may be that they act as a splashguard. More specifically, the first and second protrusions 230, 240 may reduce the amount of oil or other liquid from the reservoir that makes its way into the housing 110 of the breather 100. The first and second protrusion 230, 240 may block the oil or other liquid that splashes into the standpipe 200 and allow the oil or other liquid to drain back into the reservoir. Furthermore, the first and second protrusions 230, 240 may still allow for adequate airflow through the standpipe 200.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A breather for a reservoir, the breather comprising:
a housing having a standpipe for at least receiving an air flow containing oil;
a first end configured for at least receiving the air flow containing oil into the standpipe, the first end having a single flow passage configured to receive both air flow and coalesced oil via the air flow containing oil; and
a second end located at an opposite side of the standpipe from the first end, the second end parallel to the first end and configured for at least emitting air from the standpipe;
wherein the standpipe includes first and second protrusions integrally formed in an inner wall of the standpipe, the first protrusion having a first protrusion peak and the second protrusion having a second protrusion peak, the first protrusion peak and the second protrusion peak extending in opposite directions forming an airflow distance.

2. The breather of claim 1, wherein:
each of the first and second protrusions include a proximal sloped section and a distal sloped section.

3. The breather of claim 1, wherein:
the first and second protrusion peaks are curved.

4. The breather of claim 1, wherein:
an offset distance between the first protrusion peak and the second protrusion peak is in a range of from 5 to 30 millimeters.

5. The breather of claim 1, wherein:
an offset distance between the first protrusion peak and the second protrusion peak is similar to an inner diameter of the standpipe.

6. The breather of claim 1, wherein:
a gap distance between the first protrusion peak and the second protrusion peak is in a range of from 1 to 10 millimeters.

7. The breather of claim 1, wherein:
the airflow distance is in a range of from 1 to 20 millimeters.

8. The breather of claim 1, wherein:
the first and second protrusions are located closer to a proximal end of the standpipe than to a distal end of the standpipe.

9. The breather of claim 1, wherein:
in a linear cross-section of the standpipe, the first and second protrusions form an S-shaped curve.

10. The breather of claim 1, wherein:
the first and second protrusions extend from the inner wall of the standpipe at least halfway across an inner diameter of the standpipe.

11. The breather of claim 1, wherein:
the first and second protrusions extend from the inner wall of the standpipe no further than halfway across an inner diameter of the standpipe.

12. The breather of claim 1, wherein:
the standpipe includes first and second indentations formed in an outer wall of the standpipe, the first and second indentations corresponding to the first and second protrusions, respectively; and
the standpipe includes a one or more ribs extending within the first and second indentations.

13. The breather of claim 1, wherein:
the standpipe includes third and fourth protrusions integrally formed in the inner wall of the standpipe.

14. The breather of claim 1, wherein:
the first and second protrusions include an airflow reduction factor no greater than 20.

15. A standpipe for a breather, the standpipe comprising:
a substantially cylindrical body; and
first and second protrusions integrally formed in an inner wall of the standpipe, the first protrusion having a first protrusion peak and the second protrusion having a second protrusion peak, the first protrusion peak and the second protrusion peak extending in opposite directions forming an airflow distance;
wherein in a linear cross-section of the standpipe, the first and second protrusions form an S-shaped curve.

16. The standpipe of claim 15, wherein:
an offset distance between the first protrusion peak and the second protrusion peak is in a range of from 5 to 30 millimeters.

17. The standpipe of claim 15, wherein:
a gap distance between the first protrusion peak and the second protrusion peak is in a range of from 1 to 10 millimeters.

18. The standpipe of claim 15, wherein:
the airflow distance is in a range of from 1 to 20 millimeters.

19. The standpipe of claim 15, wherein:
the first and second protrusions extend from the inner wall of the standpipe at least halfway across an inner diameter of the standpipe.

20. The standpipe of claim 15, wherein:
the first and second protrusions extend from the inner wall of the standpipe no further than halfway across an inner diameter of the standpipe.
